(19) United States
(12) Patent Application Publication
(10) Pub. No.: US 2026/0156281 A1
(43) Pub. Date: Jun. 4, 2026

(54) VIDEO DATA CONTROL METHOD, ELECTRONIC DEVICE, AND COMPUTER STORAGE MEDIUM

(71) Applicant: Amlogic Technology (Beijing) Co., Ltd, Beijing (CN)

(72) Inventor: Tao GUO, Beijing (CN)

(21) Appl. No.: 19/457,357

(22) Filed: Jan. 23, 2026

Related U.S. Application Data
(63) Continuation of application No. PCT/CN2023/137408, filed on Dec. 8, 2023.

(51) Int. Cl. H04N 19/423; H04N 19/156; H04N 19/172

(52) U.S. Cl. CPC H04N 19/423; H04N 19/156; H04N 19/172

(57) ABSTRACT

A video data control method and apparatus, and an electronic device. The video data control method includes: obtaining consecutive data frames and customized handle memories; allocating actual memories for the customized handle memories based on memories of the consecutive data frames; and decoding the consecutive data frames based on the actual memories. Optimizes a memory pool design, achieves on-demand allocation and closed-loop control of actual memories and reduces memory waste while ensuring the normal video playback.

### CROSS-REFERENCE TO RELATED APPLICATION

This application is a continuation of International Application No. PCT/CN2023/137408, filed on Dec. 8, 2023, which is hereby incorporated by reference in its entirety.

### FIELD

The present disclosure relates to the technical field of memory optimization, and more particularly, to a video data control method and apparatus, and an electronic device.

### BACKGROUND

When playing video on an Android system application, it is necessary to allocate multiple decoder input memories, which are recycled throughout the playback process. The size and number of these decoder input memories are determined by the vendor adaptation layer of a System on Chip (SoC). However, during the decision-making process, it is difficult for the adaptation layer to accurately predict the specific memory usage required for video playback, leading to contradictions. For instance, inappropriate memory size settings may result in discontinuous video playback and frame drops, while excessively large memory sizes or an excessive number of memories may cause excessive memory occupation and wastage..

### SUMMARY

The present disclosure aims to resolve at least one of the technical problems existing in the related art.

Therefore, one aim of the present disclosure is to provide a video data control method. The method optimizes a memory pool design, achieves on-demand allocation and closed-loop control of actual memories and reduces memory waste while ensuring the normal video playback.

A second aim of the present disclosure is to provide a video data control apparatus.

A third aim of the present disclosure is to provide an electronic device.

A fourth aim of the present disclosure is to provide a non-transitory computer storage medium.

To achieve the above aims, an embodiment of a first aspect of the present disclosure provides an video data control method. The method includes: obtaining consecutive data frames and customized handle memories; allocating actual memories for the customized handle memories based on memories of the consecutive data frames; and decoding the consecutive data frames based on the actual memories.

In the video data control method according to the embodiment of the present disclosure, by obtaining the consecutive data frames and the customized handle memories, the actual memories are allocated for the customized handle memories according to the different memory sizes of the consecutive data frames, and the consecutive data frames are decoded based on the actual memories. By allocating the actual memories according to the actual sizes of the consecutive data frames during the actual use, the memory pool design is optimized to achieve on-demand allocation and the closed-loop control of the actual memories, and reduce memory waste while ensuring the normal video playback.

In some embodiments, the allocating the actual memories for the customized handle memories based on the memories of the consecutive data frames includes: obtaining a first customized handle memory; and allocating the actual memories for the first customized handle memory based on the memories of the consecutive data frames.

In some embodiments, the decoding the consecutive data frames based on the actual memories includes: writing the consecutive data frames into the actual memories to obtain encrypted consecutive data frames; decrypting the encrypted consecutive data frames to obtain actual data frame addresses; and decoding the consecutive data frames based on the actual data frame addresses.

In some embodiments, the decoding the consecutive data frames based on the actual data frame addresses includes: obtaining a second customized handle memory; and decoding the consecutive data frames based on the second customized handle memory and the actual data frame addresses.

In some embodiments, the decoding the consecutive data frames based on the second customized handle memory and the actual data frame addresses includes: obtaining the consecutive data frames corresponding to the actual frame addresses; and decoding the consecutive data frames corresponding to the actual frame addresses in the second customized handle memory.

In some embodiments, after the decoding the consecutive data frames based on the actual memories, the method further includes: sending, after determining that decoding of a current data frame is completed, an available customized handle in the customized handle memories.

In some embodiments, the sending the available customized handle in the customized handle memories includes: predicting a size of a memory required to be released for a next data frame during an actual memory release process; and delaying, when the memory required to be released exceeds a maximum allocatable memory, sending the available customized handle.

In some embodiments, before the predicting during the actual memory release process, the method further includes: determining an order in which the memories for the consecutive data frames are to be released; and sequentially releasing the actual memories based on the order.

To achieve the above aims, an embodiment of a second aspect of the present disclosure provides a video data control apparatus. The apparatus includes: an obtaining module configured to obtain consecutive data frames and customized handle memories; an allocating module configured to allocate actual memories for the consecutive data frames based on the customized handle memories; and a decoding module configured to decode the consecutive data frames based on the actual memories.

In the video data control apparatus according to the embodiment of the present disclosure, by obtaining the consecutive data frames and the customized handle memories, the actual memories are allocated for the customized handle memories according to the different memory sizes of the consecutive data frames, and the consecutive data frames are decoded based on the actual memories. By allocating actual memories according to the actual sizes of the consecutive data frames during the actual use, the memory pool design is optimized to achieve on-demand allocation and the closed-loop control of the actual memories, and reduce memory waste while ensuring the normal video playback.

To achieve the above aims, an embodiment of a third aspect of the present disclosure provides an electronic device. The device includes: at least one processor; and a memory communicatively connected to the at least one processor. The memory stores a computer program executable by the at least one processor. The computer program when executed by the at least one processor, implements steps of the video data control method in any of the above embodiments.

In the electronic device of the embodiment of the present disclosure, by obtaining the consecutive data frames and the customized handle memories, the actual memories are allocated for the customized handle memories according to the different memory sizes of the consecutive data frames, and the consecutive data frames are decoded based on the actual memories. By allocating actual memories according to the actual sizes of the consecutive data frames during the actual use, the memory pool design is optimized to achieve on-demand allocation and the closed-loop control of the actual memories, and reduce memory waste while ensuring the normal video playback.

To achieve the above aims, an embodiment of a fourth aspect of the present disclosure provides a non-transitory computer storage medium, on which a computer program is stored. The computer program when executed by a processor, implements steps of the video data control method in any of the above embodiments.

The additional aspects and advantages of the present disclosure will be partially presented in the following description, partially become apparent from the description below, or be understood through the practice of the present disclosure.

### BRIEF DESCRIPTION OF THE DRAWINGS

The above and/or additional aspects and advantages of the present disclosure will become apparent and comprehensible from the description of embodiments in connection with accompanying drawings, in which:

FIG. 1 is a flow chart of a video data control method according to an embodiment of the present disclosure;

FIG. 2 is a flow chart of a video data control method according to an embodiment of the present disclosure;

FIG. 3 is a block diagram showing a structure of a video data control apparatus according to an embodiment of the present disclosure; and

FIG. 4 is a block diagram showing a structure of an electronic device according to an embodiment of the present disclosure.

Reference numerals:
Video data control apparatus 2;
Obtaining module 21; Allocating module 22; Decoding module 23
Electronic device 3.

### DETAILED DESCRIPTION

The following describes the embodiments of the present disclosure in detail. The embodiments described with reference to the accompanying drawings are exemplary.

In the description of the present disclosure, it should be understood that the terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, and “circumferential” indicate orientations or positional relationships based on the orientations or positional relationships shown in the accompanying drawings. These terms are used solely for the purpose of facilitating the description of the present disclosure and simplifying the description, and are not intended to indicate or imply that the apparatus or elements referred to must necessarily have a specific orientation, be constructed in a specific orientation, or operate in a specific orientation. Therefore, they should not be construed as limitations on the present disclosure.

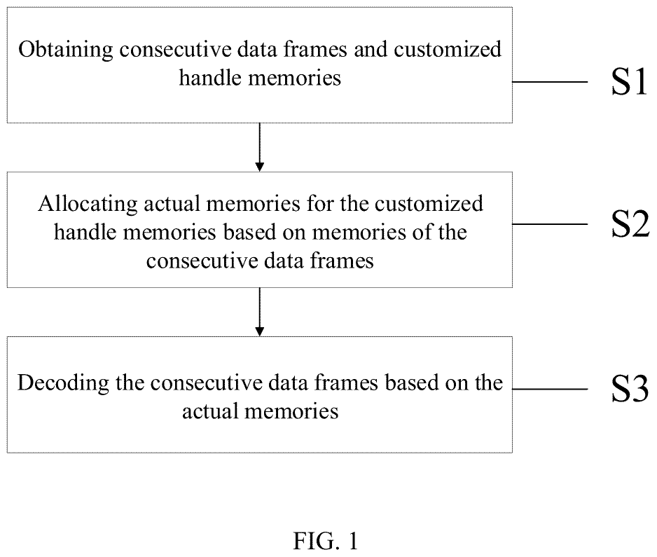

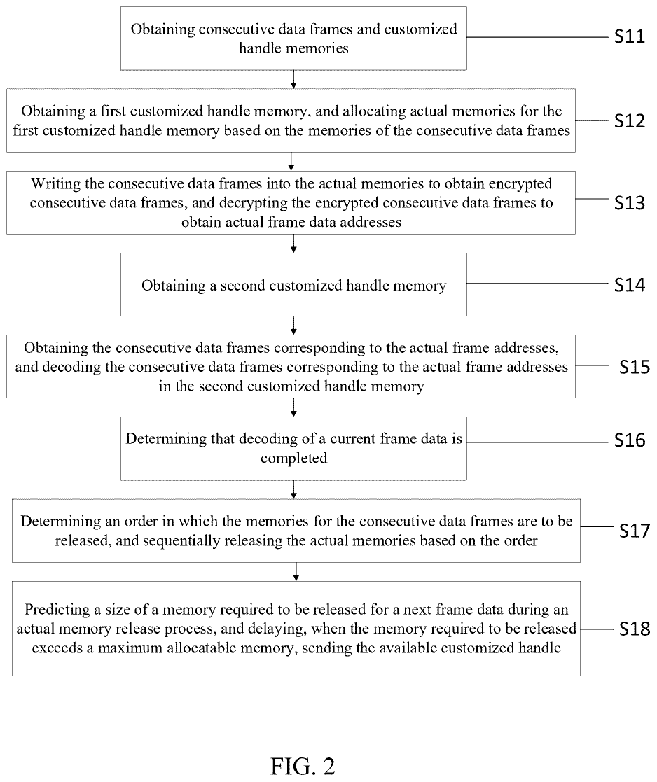

The following describes a video data control method according to an embodiment of the present disclosure with reference to FIG. 1 and FIG. 2.

As shown in FIG. 1, the video data control method according to the embodiment of the present disclosure at least includes steps S1 to S3.

At step S1, consecutive data frames and customized handle memories are obtained.

Consecutive data frames refers to data with known memory sizes and sequential order during the video playback process. Since the sizes of consecutive data frames are known during actual usage, memory allocation can be performed based on memory requirements of the consecutive data frames.

Since memories are arranged sequentially, the consecutive data frames are densely packed together. When there is insufficient free space at the end, allocation loops back to a beginning of the memory pool. The sizes of the consecutive data frames fluctuate significantly, that is, some data frames have a large size, and some other data frames have a small size. The customized handle memories refer to specific handle memories stored in a native handle structure of Android. When the customized handle memories, as identifiers in the process of memory allocation, are identified, actual memories corresponding to the consecutive data frames are allocated for them.

In the embodiment, at a certain moment during video playback, the consecutive data frames are obtained, and customized handle memories stored within an Android native handle are obtained by invoking a dedicated Application Programming Interface (API). By obtaining the consecutive data frames and the customized handle memories, data support is provided for subsequent memory usage.

At step S2, actual memories are allocated for the customized handle memories based on memories of the consecutive data frames.

In the embodiment, after obtaining the consecutive data frames and the customized handle memories, a hook function is inserted when an Android Package (APK) sends a frame of data to the decoder. In the hook function, the sizes of the memories of the consecutive data frames can be obtained and the customized handle memories in the Android native handle are identified. Actual memories are allocated for the customized handle memories based on the sizes of memories of the consecutive data frames. Subsequently, the frame-sending call is performed to complete the writing of the consecutive data frames. During actual use, actual memories are allocated for the customized handle memories based on the sizes of memories of the consecutive data frames to store the consecutive data frames, so that the sizes of memories adapt to the sizes of the consecutive data frames, optimizing memory pool design, implementing on-demand memory allocation and reducing the problem of memory waste.

At step S3, the consecutive data frames are decoded based on the actual memories.

In the embodiment, after obtaining the actual memories, the decoder identifies that the actual memories are in Android native handle mode and then extracts the customized handle memories stored in the Android native handle and obtains true data frame addresses based on the consecutive data frames and the actual memories, and then decodes the consecutive data frames corresponding to the true data frame addresses, achieving closed-loop control of the actual memories to ensure normal video playback

In the video data control method according to the embodiment of the present disclosure, after obtaining the consecutive data frames and the customized handle memories, the actual memories are allocated for the customized handle memories according to the different memory sizes of the consecutive data frames, and the consecutive data frames are decoded based on the actual memories. By allocating actual memories according to the actual sizes of the consecutive data frames during the actual use, the memory pool design is optimized to achieve on-demand allocation and the closed-loop control of the actual memories, and reduce memory waste while ensuring the normal video playback.

In some embodiments, when the actual memories are allocated for the customized handle memories based on the memories of the consecutive data frames, a first customized handle memory is obtained and the actual memories are allocated for the first customized handle memory based on the memories of the consecutive data frames.

In an embodiment, the actual memories are allocated for the consecutive data frames. For example, when the decoder receives a data frame sent by the APK, the hook function is added in. In the hook function, the memory sizes of the consecutive data frames can be obtained. At this time, the dedicated API is invoked to extract the first customized handle memory stored in the Android native handle and the actual memories are allocated for the first customized handle memory based on the memories of the consecutive data frames, thereby avoiding excessive actual memory usage and memory waste caused by using the native buffer.

For example, the consecutive data frames consist of four data frames with memory sizes of 3MB, 1MB, 1MB, and 2MB respectively. The first customized handle memory consisting of memories for the four customized handles is obtained. Actual memories of 3MB, 1MB, 1MB, and 2MB respectively are allocated for the first customized handle memory i.e., these four customized handle memories based on memories of the consecutive data frames with sizes of 3MB, 1MB, 1MB, and 2MB. A total actual memory occupied for video playback is 7MB. If four native buffers are used, the memory for each native buffer is set to 5MB and the total actual memory occupied for video playback would be 20MB. In this way, the memory is greatly reduced.

In some embodiments, the decoding the consecutive data frames based on the actual memories includes: writing the consecutive data frames into the actual memories to obtain encrypted consecutive data frames; decrypting the encrypted consecutive data frames to obtain actual data frame addresses; and decoding the consecutive data frames based on the actual data frame addresses.

In the embodiment, after the actual memories are obtained, the consecutive data frames are written into the actual memories to obtain encrypted consecutive data frames. The decoder decrypts the encrypted consecutive data frames to convert them to actual data frame addresses. In this way, the consecutive data frames are decoded based on the actual data frame addresses, thereby ensuring normal video playback.

In some embodiments, the decoding the consecutive data frames based on the actual data frame addresses includes: obtaining a second customized handle memory; and decoding the consecutive data frames based on the second customized handle memory and the actual data frame addresses.

In an embodiment, after the actual data frame addresses are obtained, a dedicated API is invoked to extract the second customized handle memory stored in the Android native handle, so as to decode the consecutive data frames based on the second customized handle memory and the actual data frame addresses, thereby ensuring normal video playback.

In some embodiments, the decoding the consecutive data frames based on the second customized handle memory and the actual data frame addresses includes: obtaining the consecutive data frames corresponding to the actual frame addresses; and decoding the consecutive data frames corresponding to the actual frame addresses in the second customized handle memory.

In an embodiment, after the actual data frame addresses and the second customized handle memory are obtained, the consecutive data frames corresponding to the actual frame addresses are obtained. The consecutive data frames corresponding to the actual frame address are decoded in the second customized handle memory, thereby ensuring normal video playback.

In some embodiments, after the decoding the consecutive data frames based on the actual memories, the method further includes: sending, after determining that decoding of a current data frame is completed, an available customized handle in the customized handle memories.

In an embodiment, after determining that decoding of a current data frame is completed, an available customized handle that is a free handle in the customized handle memories is sent, an upper layer is notified that the actual memory usage has been completed, thereby achieving closed-loop usage of the memories. That is, each time the APK sends a data frame to the decoder, an actual memory is allocated for the customized handle memory. Each time a data frame is decoded, the actual memory is released from the customized handle memory and the customized handle memory is sent to the APK for use in a next transmission of data.

In some embodiments, the sending the available customized handle in the customized handle memories includes: predicting a size of a memory required to be released for a next data frame during an actual memory release process; and delaying, when the memory required to be released exceeds a maximum allocatable memory, sending the available customized handle.

In an embodiment, after determining that decoding of the current data frame is completed, a size of a memory required to be released for a next data frame during an actual memory release process is predicted according to an embedded algorithm. When the memory required to be released exceeds a maximum allocatable memory, a flow control is triggered to control the return of the native buffer, thereby delaying the sending of the available customized handle i.e., the idle handle, and consequently controlling the data flow rate. By introducing a prediction mechanism, this prevents playback issues that may arise when the data volumes of consecutive data frames are consistently large, which could otherwise cause the actual memories to exceed the total capacity of the memory pool.

In some embodiments, before the predicting during the actual memory release process, the method further includes: determining an order in which the memories for the consecutive data frames are to be released; and sequentially releasing the actual memories based on the order.

In an embodiment, before the predicting during the actual memory release process, the order in which the memories for the consecutive data frames are to be released for example a time order is determined, and thus the actual memories are sequentially released based on the order, that is the actual memories allocated first are released first. The actual memories are not allowed to be released unless they are released sequentially in order.

In the present application, while maintaining the same total actual memory occupancy during video playback, the number of native buffers can be increased, for example, can be set to 32, such that the maximum tolerable network interruption time becomes 533 ms. This avoids the situation in which there are always only four native buffers during playback. When network fluctuations occur, the maximum tolerable network interruption time would be 4*1000/frame rate (ms), for instance, for a 60 fps (Frames Per Second) video, exceeding this duration would cause video stuttering or frame drops.

A video data control method of an embodiment of the present disclosure is described below by way of example with reference to FIG. 2.

As shown in FIG. 2, the video data control method of the embodiment of the present disclosure at least includes steps S11 to S18.

At step S11, consecutive data frames and customized handle memories are obtained.

At step S12, a first customized handle memory is obtained, and actual memories are allocated for the first customized handle memory based on the memories of the consecutive data frames.

At step S13, the consecutive data frames are written into the actual memories to obtain encrypted consecutive data frames, and the encrypted consecutive data frames are decrypted to obtain actual data frame addresses.

At step S14, a second customized handle memory is obtained.

At step S15, the consecutive data frames corresponding to the actual frame addresses are obtained, and the consecutive data frames corresponding to the actual frame addresses are decoded in the second customized handle memory.

At step S16, it is determined that decoding of a current data frame is completed.

At step S17, an order in which the memories for the consecutive data frames are to be released is determined, and the actual memories are sequentially released based on the order.

At step S18, a size of a memory required to be released for a next data frame during an actual memory release process is predicted, and when the memory required to be released exceeds a maximum allocatable memory, sending the available customized handle is delayed.

In the video data control method according to the embodiment of the present disclosure, after obtaining the consecutive data frames and the customized handle memories, the actual memories are allocated for the customized handle memories according to the different memory sizes of the consecutive data frames, and the consecutive data frames are decoded based on the actual memories. By allocating actual memories according to the actual sizes of the consecutive data frames during the actual use, the memory pool design is optimized to achieve on-demand allocation and the closed-loop control of the actual memories, and reduce memory waste while ensuring the normal video playback.

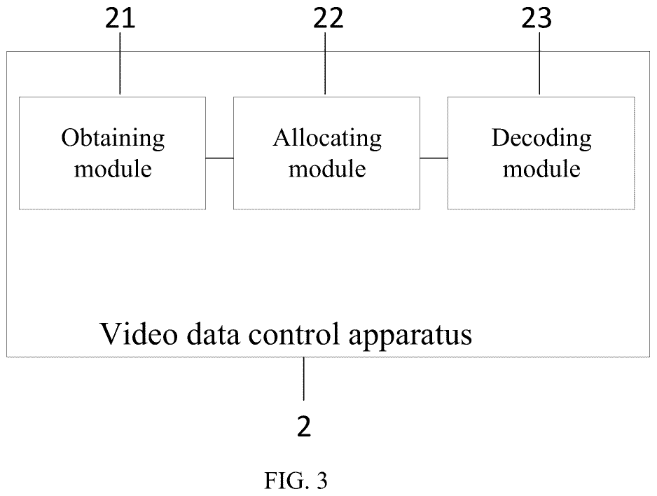

A video data control apparatus 2 of an embodiment of the present disclosure is described below with reference to FIG. 3.

As shown in FIG. 3, the video data control apparatus 2 of the embodiment of the present disclosure includes an obtaining module 21, an allocating module 22 and a decoding module 23.

The obtaining module 21 is configured to obtain consecutive data frames and customized handle memories. The allocating module 22 is configured to allocate actual memories for the consecutive data frames based on the customized handle memories. The decoding module 23 is configured to decode the consecutive data frames based on the actual memories.

In the embodiment, at a certain moment during video playback, the obtaining module 21 obtains the consecutive data frames, and obtains customized handle memories stored within an Android native handle by invoking a dedicated Application Programming Interface (API). By obtaining the consecutive data frames and the customized handle memories, data support is provided for subsequent memory usage. The consecutive data frames refer to data with known memory sizes and sequential order during the video playback process. Since the sizes of consecutive data frames are known during actual usage, memory allocation can be performed based on memory requirements of the consecutive data frames.

Since memories are arranged sequentially, the consecutive data frames are densely packed together. When there is insufficient free space at the end, allocation loops back to a beginning of the memory pool. The sizes of consecutive data frames fluctuate significantly, that is, some data frames have a large size, and some other data frames have a small size. The customized handle memories refer to specific handle memories stored in a native handle structure of Android. When the customized handle memories, as identifiers in the process of memory allocation, are identified, actual memories corresponding to the consecutive data frames are allocated for them.

After the allocating module 22 obtains the consecutive data frames and the customized handle memories, a hook function is inserted when an Android Package (APK) sends a data frame to the decoder. In the hook function, the sizes of the memories of the consecutive data frames can be obtained and the customized handle memories in the Android native handle are identified. Actual memories are allocated for the customized handle memories based on the sizes of memories of the consecutive data frames. Subsequently, the frame-sending call is performed to complete the writing of the consecutive data frames. During actual use, actual memories are allocated for the customized handle memories based on the sizes of memories of the consecutive data frames to store the consecutive data frames, so that the sizes of memories adapt to the sizes of the consecutive data frames, optimizing memory pool design, implementing on-demand memory allocation and reducing the problem of memory waste.

After the decoding module 23 obtains the actual memories, the decoder identifies that the actual memories are in Android native handle mode and then extracts the customized handle memories stored in the Android native handle and obtains true data frame addresses based on the consecutive data frames and the actual memories, and then decodes the consecutive data frames corresponding to the true data frame addresses, achieving closed-loop control of the actual memories to ensure normal video playback.

In the video data control apparatus 2 according to the embodiment of the present disclosure, after obtaining the consecutive data frames and the customized handle memories, the actual memories are allocated for the customized handle memories according to the different memory sizes of the consecutive data frames, and the consecutive data frames are decoded based on the actual memories. By allocating actual memories according to the actual sizes of the consecutive data frames during the actual use, the memory pool design is optimized to achieve on-demand allocation and the closed-loop control of the actual memories, and reduce memory waste while ensuring the normal video playback.

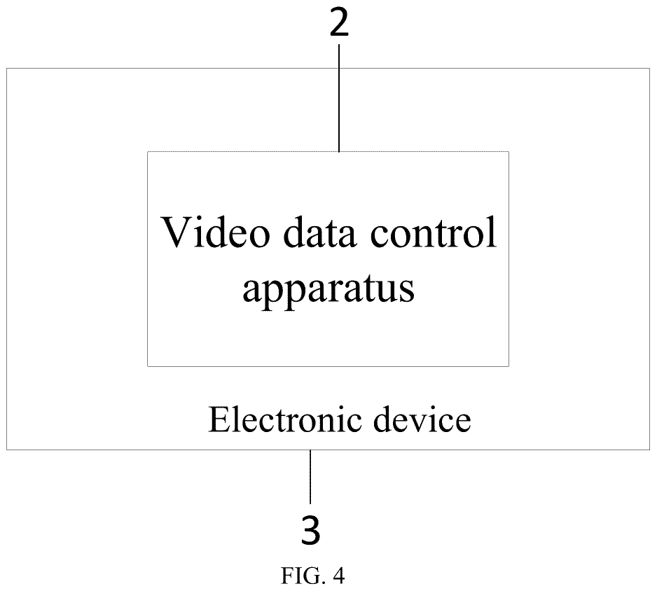

The following describes an electronic device 3 of an embodiment of the present disclosure with reference to FIG. 4.

As shown in FIG. 4, the electronic device 3 of the embodiment of the present disclosure includes the video data control apparatus 2 according to any of the above embodiments.

In the electronic device 3 of the embodiment of the present disclosure, by obtaining the consecutive data frames and the customized handle memories, the actual memories are allocated for the customized handle memories according to the different memory sizes of the consecutive data frames, and the consecutive data frames are decoded based on the actual memories. By allocating actual memory according to the actual sizes of the consecutive data frames during the actual use, the memory pool design is optimized to achieve on-demand allocation and the closed-loop control of the actual memories, and reduce memory waste while ensuring the normal video playback.

An electronic device according to an embodiment of the present disclosure is described below. In some embodiments, the electronic device of the embodiment of the present disclosure includes: at least one processor; and a memory communicatively connected to the at least one processor. The memory stores a computer program executable by the at least one processor. The computer program when executed by the at least one processor, implements steps of the video data control method in any of the above embodiments.

A non-transitory computer storage medium according to an embodiment of the present disclosure is described below. A computer program is stored on the non-transitory computer storage medium. The computer program when executed by a processor, implements steps of the video data control method in any of the above embodiments.

In the illustration of the present disclosure, a description with reference to the terms such as “one embodiment”, “some embodiments”, “exemplary embodiments”, “examples”, “specific examples”, or “some examples” means that a specific feature, structure, material, or characteristic described in connection with the embodiment or example is included in at least one embodiment or example of the present disclosure. In the present description, schematic expressions of the above terms do not necessarily refer to the same embodiments or examples.

Although embodiments of the present disclosure have been shown and described, those of ordinary skill in the art can understand that various changes, modifications, substitutions, and variations can be made to these embodiments without departing from the principles and spirit of the present disclosure. The scope of the present disclosure is defined by the claims and their equivalents.

What is claimed is:

1. A video data control method, comprising:
obtaining consecutive data frames and customized handle memories;
allocating actual memories for the customized handle memories based on memories of the consecutive data frames; and
decoding the consecutive data frames based on the actual memories.

2. The video data control method according to claim 1, wherein said allocating the actual memories for the customized handle memories based on the memories of the consecutive data frames comprises:
obtaining a first customized handle memory; and
allocating the actual memories for the first customized handle memory based on the memories of the consecutive data frames.

3. The video data control method according to claim 1, wherein said decoding the consecutive data frames based on the actual memories comprises:
writing the consecutive data frames into the actual memories to obtain encrypted consecutive data frames;
decrypting the encrypted consecutive data frames to obtain actual data frame addresses; and
decoding the consecutive data frames based on the actual data frame addresses.

4. The video data control method according to claim 3, wherein said decoding the consecutive data frames based on the actual data frame addresses comprises:
obtaining a second customized handle memory; and
decoding the consecutive data frames based on the second customized handle memory and the actual data frame addresses.

5. The video data control method according to claim 4, wherein said decoding the consecutive data frames based on the second customized handle memory and the actual data frame addresses comprises:
obtaining the consecutive data frames corresponding to the actual frame addresses; and
decoding the consecutive data frames corresponding to the actual frame addresses in the second customized handle memory.

6. The video data control method according to claim 1, further comprising: after the decoding the consecutive data frames based on the actual memories,
sending, after determining that decoding of a current data frame is completed, an available customized handle in the customized handle memories.

7. The video data control method according to claim 6, wherein said sending the available customized handle in the customized handle memories comprises:
predicting a size of a memory required to be released for a next data frame during an actual memory release process; and
delaying, when the memory required to be released exceeds a maximum allocatable memory, sending the available customized handle.

8. The video data control method according to claim 7, further comprising: before the predicting during the actual memory release process,
determining an order in which the memories for the consecutive data frames are to be released; and
sequentially releasing the actual memories based on the order.

9. An electronic device, comprising:
at least one processor; and
a memory communicatively connected to the at least one processor, wherein the memory stores a computer program executable by the at least one processor, the computer program when executed by the at least one processor, implements operations of:
obtaining consecutive data frames and customized handle memories;
allocating actual memories for the customized handle memories based on memories of the consecutive data frames; and
decoding the consecutive data frames based on the actual memories.

10. The electronic device according to claim 9, wherein said allocating the actual memories for the customized handle memories based on the memories of the consecutive data frames comprises:
obtaining a first customized handle memory; and
allocating the actual memories for the first customized handle memory based on the memories of the consecutive data frames.

11. The electronic device according to claim 9, wherein said decoding the consecutive data frames based on the actual memories comprises:
writing the consecutive data frames into the actual memories to obtain encrypted consecutive data frames;
decrypting the encrypted consecutive data frames to obtain actual data frame addresses; and
decoding the consecutive data frames based on the actual data frame addresses.

12. The electronic device according to claim 11, wherein said decoding the consecutive data frames based on the actual data frame addresses comprises:
obtaining a second customized handle memory; and
decoding the consecutive data frames based on the second customized handle memory and the actual data frame addresses.

13. The electronic device according to claim 12, wherein said decoding the consecutive data frames based on the second customized handle memory and the actual data frame addresses comprises:
obtaining the consecutive data frames corresponding to the actual frame addresses; and
decoding the consecutive data frames corresponding to the actual frame addresses in the second customized handle memory.

14. The electronic device according to claim 9, further comprising, after the decoding the consecutive data frames based on the actual memories:
sending, after determining that decoding of a current data frame is completed, an available customized handle in the customized handle memories.

15. The electronic device according to claim 14, wherein said sending the available customized handle in the customized handle memories comprises:
predicting a size of a memory required to be released for a next data frame during an actual memory release process; and
delaying, when the memory required to be released exceeds a maximum allocatable memory, sending the available customized handle.

16. The electronic device according to claim 15, further comprising, before the predicting during the actual memory release process:
determining an order in which the memories for the consecutive data frames are to be released; and
sequentially releasing the actual memories based on the order.

17. A non-transitory computer storage medium, on which a computer program is stored, wherein the computer program when executed by a processor, implements operations of:
obtaining consecutive data frames and customized handle memories;
allocating actual memories for the customized handle memories based on memories of the consecutive data frames; and
decoding the consecutive data frames based on the actual memories.

18. The non-transitory computer storage medium according to claim 17, wherein said allocating the actual memories for the customized handle memories based on the memories of the consecutive data frames comprises:
obtaining a first customized handle memory; and
allocating the actual memories for the first customized handle memory based on the memories of the consecutive data frames.

19. The non-transitory computer storage medium according to claim 17, wherein said decoding the consecutive data frames based on the actual memories comprises:
writing the consecutive data frames into the actual memories to obtain encrypted consecutive data frames;
decrypting the encrypted consecutive data frames to obtain actual data frame addresses; and
decoding the consecutive data frames based on the actual data frame addresses.

20. The non-transitory computer storage medium according to claim 19, wherein said decoding the consecutive data frames based on the actual data frame addresses comprises:
obtaining a second customized handle memory; and
decoding the consecutive data frames based on the second customized handle memory and the actual data frame addresses.
